(19) United States
(12) Patent Application Publication
(10) Pub. No.: US 2012/0244927 A1
(43) Pub. Date: Sep. 27, 2012

(54) ELECTRONIC SYSTEM AND METHOD FOR A GAME OF BINGO

(75) Inventors: Robert Weatherby, Celina, TX (US); Jerome Michael Caldwell, Williamston, SC (US)

(73) Assignee: GATEWAY GAMING, LLC, Piedmont, SC (US)

(21) Appl. No.: 13/484,529

(22) Filed: May 31, 2012

Related U.S. Application Data
(63) Continuation of application No. 12/770,611, filed on Apr. 29, 2010.
(60) Provisional application No. 61/173,749, filed on Apr. 29, 2009.

(51) Int. Cl. A63F 13/00

(52) U.S. Cl. 463/19

(57) ABSTRACT

A system and method for providing a game of chance and proceeding with the game only after determining that the game involves at least two users and that at least one of the game boards of the users will present a game winning pattern and awarding a prize to a winner of the game.

### CROSS-REFERENCE TO RELATED APPLICATIONS

The present application claims the benefit of U.S. provisional patent application Ser. No. 61/173,749, entitled ELECTRONIC SYSTEM AND METHOD FOR A GAME OF BINGO and filed on Apr. 29, 2009, the entire disclosure of which is incorporated by reference for all purposes as if set forth verbatim herein.

### FIELD OF THE INVENTION

The present invention relates generally to games of chance, and, more particularly, to an electronic system and method for a game of bingo.

### BACKGROUND OF THE INVENTION

Bingo is a game of chance generally played on a card resembling a 5×5 matrix. FIG. 1 illustrates a typical bingo card 100 comprising a table 102 having five columns (104, 106, 108, 110, and 112) and five rows (114, 116, 118, 120, and 122). The word “BINGO” (denoted at 124) is set forth above table 102 such that each letter in the word corresponds to a respective column. For instance, the letter “B” corresponds to the first column 104. A unique number (but commonly denoted at 126) occupies each cell of the table.

Bingo cards, such as card 100, may be generated randomly. That is, the numbers occupying each cell may be randomly selected from a predetermined range of numbers. For instance, a number to be located in a cell in column 104 may be randomly selected from a predetermined range of numbers, such as the range of 1 to 15. Once a number has been selected and written into the corresponding cell, it is removed from the available numbers in the predetermined range. Another number is then randomly selected from the remaining numbers in the predetermined range and written into the next available cell in column 104. This process is repeated until unique numbers within the range have been written in all the cells within column 104 and then repeated for each of the remaining four columns: 106, 108, 110, and 112. Typically, the predetermined range for the numbers to be written in the cells of column 106 are 16 to 30; and for column 108, 31 to 45; column 110, 46 to 60; and column 112, 61 to 75. Those of ordinary skill in the art will appreciate that, in such a configuration, each selected number will only appear in a specific column. That is, the number “50” will only appear in a cell located in column 110 but may appear in any of the cells in column 110. It should be understood that other configurations may be used for creating bingo cards, such as randomly selecting numbers from a predetermined range of 1 to 75 for all five columns instead of limiting each column to a range of numbers. Random generation of bingo cards may be accomplished by hand or by using computer automation. For instance, electronic versions of the game of bingo randomly generate electronic bingo cards, such as an electronic version of bingo card 100.

The game of bingo is played by randomly selecting a number from the overall pool of numbers (1 through 75 for purposes of the present example) and presenting the number to the players in a sequential fashion. It should be understood that the range of numbers associated with each column of the bingo card may be varied as long as the pool of numbers includes only (and all of) the numbers within the associated ranges. The players mark or “dob” their respective boards with a marker or other indicator if the number appears on the player's board. The selection and presentation of each number is generally accomplished by a moderator or may be automated and performed electronically via a display.

Prior to initiation of each game, the moderator or system establishes certain game-winning patterns, which are configurations of a card's cells that must be marked or dobbed for a player to win the game. Examples of game-winning patterns include dobbing all five cells of a row or of a column or dobbing an “X” which includes marking the card's cells from the top left corner to the bottom right corner and the cells from the top right corner to the bottom left corner. Other less complex game-winning patterns may include merely dobbing the center cell of the card. One or more game-winning patterns may be established for each game.

When the dobs on a player's board matches a game-winning pattern, the player wins and the game is completed. Typically, the winning player is awarded a prize based on the game-winning pattern dobbed on the player's board. For instance, the prize's value may be directly proportional to the complexity of the game-winning pattern and/or the odds or likelihood of obtaining the game-winning pattern. That is, it is less likely that a player will dob his board in the “X” pattern described above than merely dobbing the card's center cell. Therefore, the prize awarded to the player should the player dob the game-winning “X” pattern is much greater than that awarded for dobbing the center cell.

As noted above, bingo is defined as a game of chance. A player may be awarded a prize upon dobbing a game-winning pattern that may include money or have a substantial monetary value. For the foregoing reasons, the administering of bingo games is often governed by statutes and regulations specific to the jurisdiction in which the game is to be conducted to which the rules of the game must adhere.

### SUMMARY OF THE INVENTION

The present invention recognizes and addresses the foregoing considerations, and others, of prior art construction and methods.

In this regard, one aspect of the present invention provides a system for conducting a game of chance played by users. The system comprises a server and at least two game terminals operatively connected to the server. Each terminal comprises a display, an input device, and a payment terminal configured to receive payment from one of the users. The server is configured to determine that the at least two game terminals are operatively connected to the server, establish at least one game winning pattern for the game, determine that a fee for the game has been paid by a user of each game terminal, generate at least one game board for each game terminal, allow the game to proceed only after the server has determined that each user has accepted the at least one game board presented via the respective user's game terminal and has determined that at least one user will win the game, and instruct one of the game terminals to award a prize to a winner of the game.

Another aspect of the present invention provides a method for providing a game of chance to multiple users. The method comprises the steps of receiving a fee from each user, presenting a game board to each user, determining that at least two users are playing the game, determining that the game board of one of the at least two users will present a winning pattern, and awarding a prize to a winner of the game.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a schematic representation of a bingo game board;

FIG. 2 is a schematic representation of a system for conducting a game of bingo in accordance with an embodiment of the present invention;

FIG. 3 is a perspective view of a game terminal of the system of FIG. 2;

FIGS. 4 and 5 are schematic representations of systems for conducting a game of bingo in accordance with various embodiments of the present invention; and

FIGS. 6 and 7 are flowcharts representing processes for conducting a game of bingo in accordance with various embodiments of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

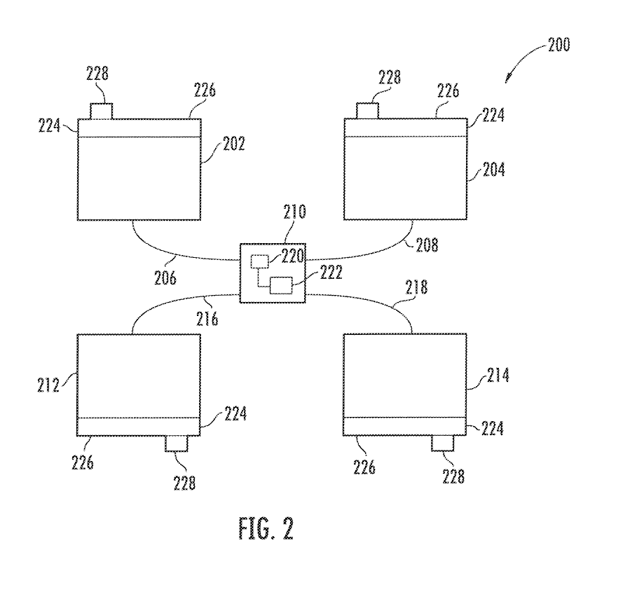

FIG. 2 illustrates a system 200 for conducting a game of chance comprising at least two game terminals 202 and 204 connected via respective connections 206 and 208 to a server 210. Additional game terminals, such as game terminals 212 and 214, may also be connected to server 210 via respective connections 216 and 218.

Server 210 comprises a processor 220 and a memory 222. Processor 220 may be a printed circuit board, processor, microprocessor, controller, or microcontroller. Memory 222 may be any memory or computer-readable medium as long as it is capable of being accessed by processor 220, including random access memory (“RAM”), read-only memory (“ROM”), erasable programmable ROM (“EPROM”) or electrically EPROM (“EEPROM”), CD-ROM, DVD, or other optical disk storage, solid state drive (“SSD”), magnetic disk storage, including floppy or hard drives, any type of non-volatile memories, such as secure digital (“SD”), flash memory, memory stick, or any other medium that may be used to carry or store computer program code in the form of computer-executable programs, instructions, or data. Additionally, when information is transferred or provided over a network or connection, such as connection 206, the receiving processor, such as processor 220, recognizes the connection as computer-readable medium. Such a connection should therefore be included in the definition of memory 222.

Memory 222 comprises computer-executable program code or instructions that when executed by processor 220 perform one or more steps of the processes described in more detail below. Memory 222 may also comprise data and one or more data structures or databases for storing information. The computer-executable program code or instructions, as should be known to those skilled in the art, usually includes an operating system, one or more application programs, other program modules, and program data.

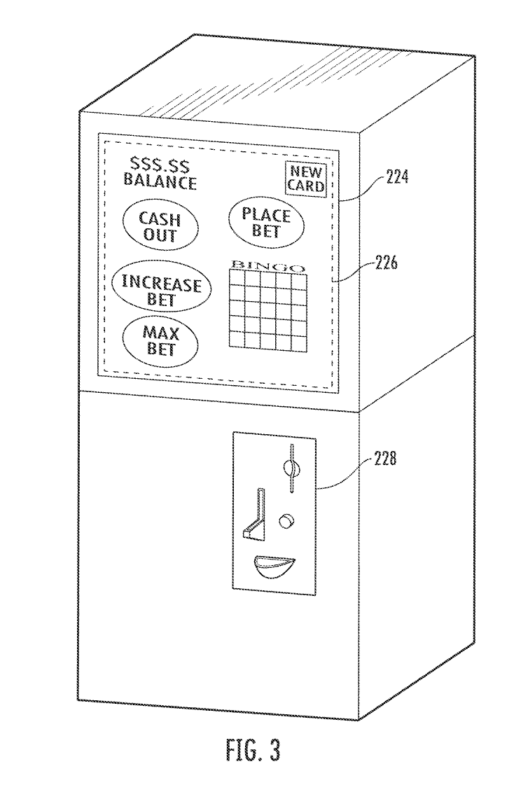

Game terminals 202, 204, 212, and 214 are identical in both construction and operation. Therefore, the following description is in reference to game terminal 202, although it should be understood to those of ordinary skill in the art that the ensuing discussion is applicable to terminals 204, 212, and 214 as well. Referring to FIGS. 2 and 3, game terminal 202 comprises a display 224 and an input 226. Input 226 may be any device that allows a user of the respective game terminal to provide instructions to the terminal, such as a keyboard, a portion of a keyboard, a numeric pad, a touchpad, a touch matrix, a set of soft keys, a mouse, or a trackball. In a preferred embodiment, the functions of input 226 and display 224 are combined, and the components are replaced with a touch screen. Accordingly, “touch screen” is used interchangeably for input 226 and display 224 for each game terminal in the following description. Each game terminal comprises a payment terminal 228 that allows the terminal to receive payment information. Payment terminal 228 may include a card reader to read payment and account information from debit and credit cards. Payment terminal 228 may also comprise a cash acceptor for receiving cash including dollar bills and change. Payment terminal 228 may also comprise a return area to provide a user with cash in the event the user is awarded a cash prize or has a balance after the user is finished playing. Alternatively, each terminal may comprise a cash and/or change dispenser separate from payment terminal 228. The construction and operation of payment terminals and cash acceptors and dispensers should be understood by those of ordinary skill in the art and are therefore not described in further detail.

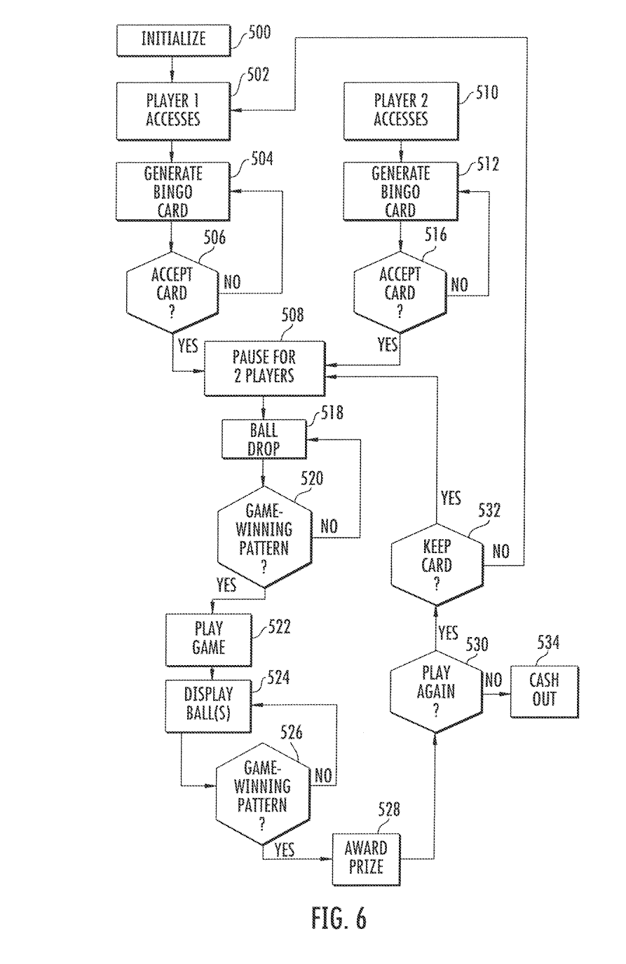

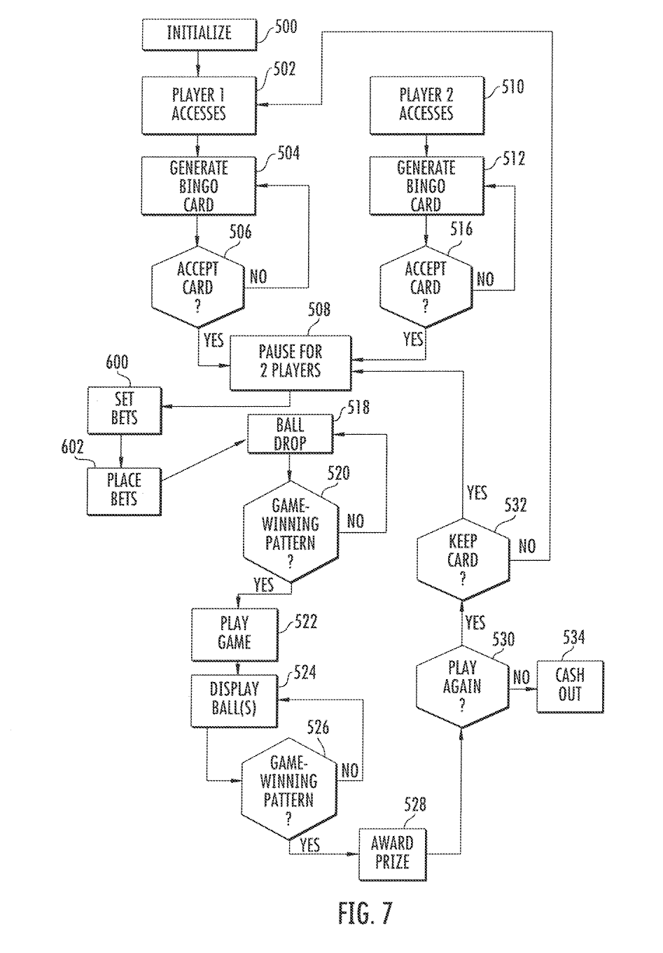

In the presently-described embodiment, connections 206, 208, 216, and 218 directly connect respective game terminals 202, 204, 212, and 214 to server 210. Server 210 handles processing of the inputs received from input 226 and controls the operation of display 224 for each game terminal. Additionally, connections 206, 208, 216, and 218 operatively connect payment terminal 228 of each game terminal to server 210. In this embodiment, server 210 performs the steps of the processes described below with respect to FIGS. 6 and 7. Such a configuration should be understood by those of ordinary skill in the art and is therefore not described in more detail.

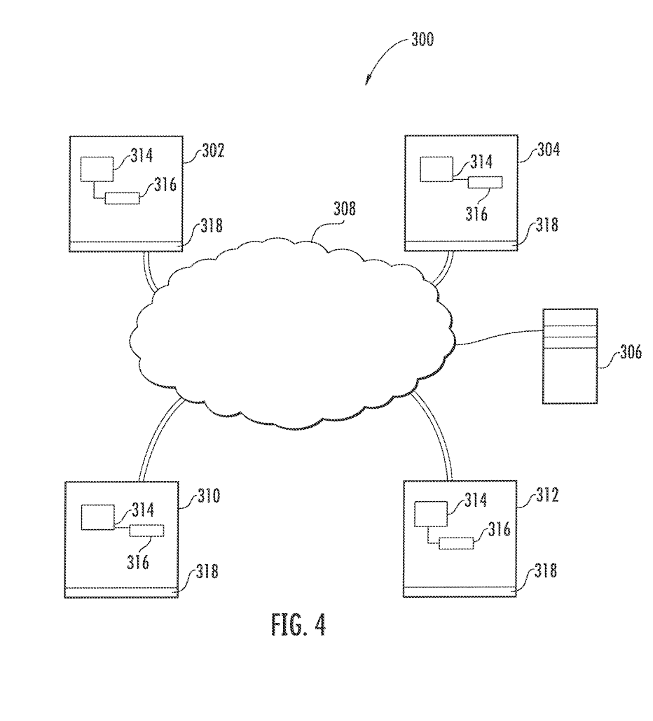

In another embodiment illustrated by FIG. 4, system 300 comprises at least two game terminals 302 and 304 operatively connected to server 306 via a connection 308. One or more game terminals, such as terminals 310 and 312 may also be connected to server 306 via connection 308. In this embodiment, connection 308 may be a local area network in the scenario where multiple game terminals are interconnected or may be a direct serial connection in the scenario involving only two game terminals. Alternatively, connection 308 may be a wide area network, such as the Internet. Additionally, connection 308 may be either a wired or a wireless connection. In the case of a wireless connection, it should be understood that connection 308 may be any wireless protocol or technology capable of interconnecting one or more terminals, such as Bluetooth, wireless fidelity (“Wi-Fi”), or a cellular data network. One will appreciate that use of wireless technologies, such as a cellular data network, or a wide area network allow game terminals 302 and 304 to be located remotely with respect to one another yet allow the users of the terminals to engage in a game of bingo as described in more detail below.

In the presently-described embodiment, game terminals 302, 304, 310, and 312 each comprise a processing device 314, a memory 316, and a touch screen 318, where the memory and touch screen are operatively connected to the processing device. Memory 316 includes computer-executable code, instructions, or programs that, when executed by processing device 314, manage the operation of touch screen 318. That is, the programs and/or modules stored on memory 316 and executed by processing device 314 control the receipt of information from touch screen 318 and the display of information to the screen. Processing device 314 transmits and receives data representative of this information to and from server 306 via connection 308. Other than the functions described above, server 306 performs the steps of the processes described below with respect to FIGS. 6 and 7.

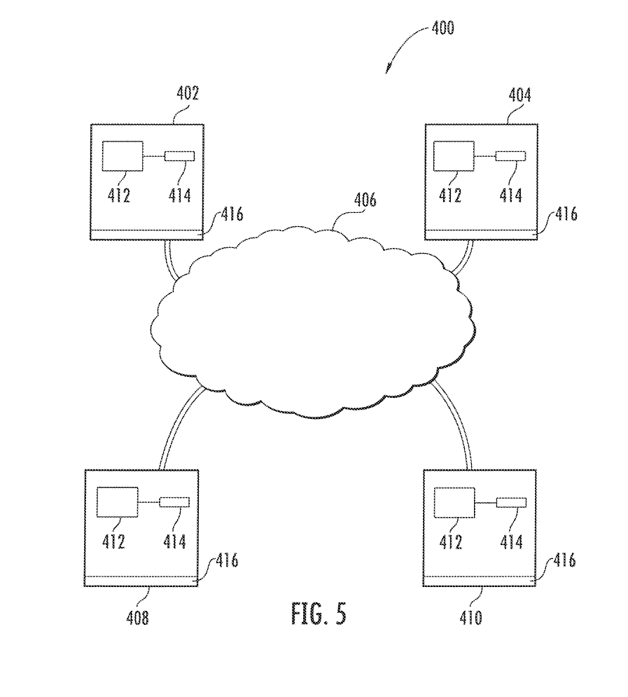

Referring to FIG. 5, in yet another embodiment, system 400 comprises at least two game terminals 402 and 404 connected via connection 406. Additional game terminals, such as terminals 408 and 410, may be connected to game terminals 402 and 404 via connection 406. In this embodiment, connection 406 may be any of the connections described above, including a direct connection or a network. Game terminals 402, 404, 408, and 410 each comprise a processing device 412, a memory 414, and a touch screen 416. Game terminals 402, 404, 408, and 410, and the components thereof, function in a manner similar to that described above with respect to FIG. 4. That is, processing device 412 controls the operation of touch screen 416 for each terminal. In this embodiment, however, one of the game terminals is selected to perform the processes described below with respect to FIGS. 6 and 7. It should be understood by those of ordinary skill in the art that the game terminal selected to perform those processes may be decided based on a number of factors, such as which game terminal is first accessed by a user.

FIG. 6 illustrates the processes for conducting a game of bingo in accordance with an embodiment of the present invention. For explanation purposes, the following description of the processes is made with respect to system 200 illustrated in FIG. 2 and game terminal 202 illustrated in FIG. 3 although it should be understood that the processes described herein are applicable to each of the embodiments set forth above with respect to FIGS. 2, 4, and 5. For instance, in the embodiment described below, processor 220 of server 210 performs the methods set forth in the following description upon execution of computer-readable code or instructions stored on memory 222. In another embodiment, however, one or more processors 412 of one or more game terminals 402, 404, 408, and 410 performs all or a portion of the methods described below upon execution of computer-readable code or instructions stored on respective memories 414.

Referring to FIGS. 2, 3, and 6, system 200 is initialized at step 500 to ensure at least two game terminals, such as terminals 202 and 204, are operational and that the connections between the game terminals and server 210, such as respective connections 206 and 208, have been established. System 200 also initializes certain variables and other options that may be set by a system administrator, such as the patterns that will be available to the players as game-winning patterns. Likewise, the award or prize corresponding to each game-winning pattern is also defined at this step. At step 502, a user (hereinafter “Player 1” for simplicity) accesses game terminal 202. This usually requires Player 1 to provide system 200 with a fee or bet, which is accomplished via payment terminal 228. The fee or bet is set by system 200 and is initialized at step 500. Those of ordinary skill in the art should appreciate that the entry fee or bet may be set to any desired predetermined amount. In a preferred embodiment, the entry fee is initialized to ten cents ($0.10). Data representative of money or credit provided by Player 1 to game terminal 202 is transmitted by payment terminal 228 of the terminal to server 210 via connection 206. Server 210 controls operation of payment terminal 228 in order to handle the money or credit provided by (or to) Player 1. As illustrated in FIG. 3, the touch screen of game terminal 202 displays other information relevant to Player 1, such as the player's running balance including any prize money awarded to the player as described below. Once the entry fee is accepted, the process continues to step 504.

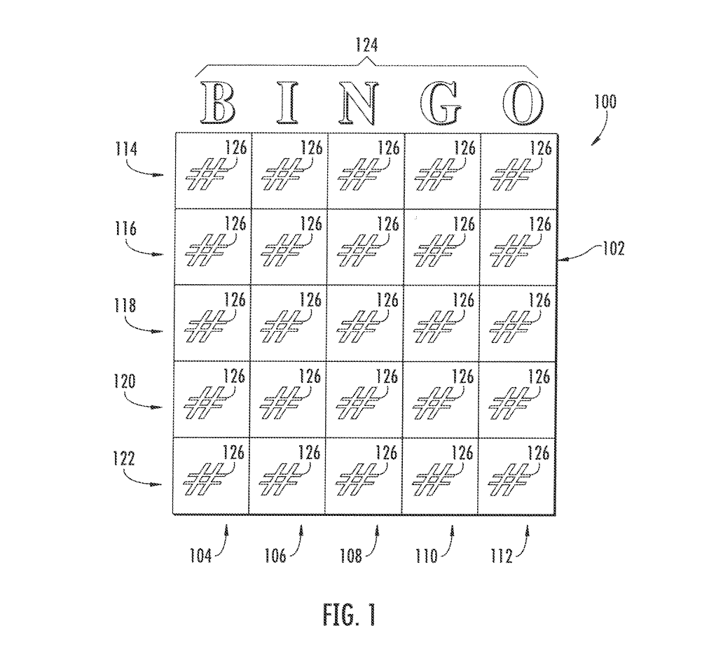

At step 504, processor 220 of server 210 randomly generates an electronic bingo card similar to the manner described above with respect to FIG. 1 based on instructions stored on memory 222. The touch screen of game terminal 202 presents the bingo card to Player 1, who may either select the card or request another card at step 506 using the touch screen. Should Player 1 request another card, process flow returns to step 504, where processor 220 generates another card. Should Player 1 select the bingo card presented by game terminal 202, process flow proceeds to step 508. This may be accomplished by Player 1 selecting a portion of the touch screen labeled “Play Game” or by Player 1 placing a bet as described below with respect to FIG. 7 by selecting a portion of the touch screen labeled “Place Bet.” Process flow pauses at step 508 until server 210 confirms another user (“Player 2”) has progressed to step 508 as described below.

Player 2 accesses game terminal 204 at step 510 by providing an entry fee similar to that described above with respect to Player 1. At step 512, system 200 (that is, processor 220) randomly generates an electronic bingo card, which server 210 presents to Player 2 via the touch screen of game terminal 204. Player 2 has the option of selecting the card or requesting another card at step 516 similar to the manner described above with respect to Player 1. Once Player 2 has selected a card, process flow proceeds to step 508.

As noted above with respect to FIG. 1, numbers 1 through 75 are typically available as a number pool in a game of bingo. At step 518, processor 220 randomly selects 30 numbers from the number pool. In the presently-described embodiment, processor 220 checks at step 520 the randomly selected 30 numbers against the randomly generated bingo cards to ensure that at least one of the cards, in combination with the random selection of numbers, will provide a game-winning pattern as identified by the system at step 500. If the random selection of the 30 numbers will not cause any of the bingo cards to present a game-winning pattern, process flow returns to step 518, where system 200 randomly selects another 30 numbers from the number pool. The process flow continues in this manner until processor 220 confirms that at least one of the bingo cards will produce a game-winning pattern based on the 30 randomly selected numbers and then continues to step 522. In a preferred embodiment, processor 220 checks, at step 520, the randomly selected numbers against the randomly generated electronic bingo cards to ensure the number located in the middle cell for at least one of the cards matches one of the numbers.

It should be understood by those of ordinary skill in the art that any game-winning pattern may be used to ensure that at least one of the players' bingo cards will result in a game-winning pattern based on the 30 numbers. It should be further understood that the process described above with respect to step 520 in each embodiment ensures that at least one of the bingo cards will result in a game-winning pattern. Those of ordinary skill in the art will appreciate that the above process does not predetermine which player will exhibit a game-winning pattern first, nor does it predetermine all of the game-winning patterns that will occur. That is, although system 200 confirms that one player's card will exhibit a game-winning pattern, another player's card may exhibit a game-winning pattern first (which may be a pattern that system 200 does not attempt to confirm exists with respect to the cards).

At step 522, processor 220 informs the players that the game is beginning via the respective touch screen of the player's game terminal. At step 524, the touch screens display one of the 30 numbers as a graphic of a bingo ball bearing the number on the front surface of the ball to the players via the touch screen of each respective game terminal. If a player's electronic bingo card includes the number displayed, the player dobs the card using the touch screen. Alternatively, processor 220 automatically dobs the player's electronic bingo card. Process flow proceeds to step 526, where processor 220 determines whether the dobs on the electronic bingo card of any player matches the game-winning patterns. If not, process flow returns to step 524 and proceeds as described above. If the dobs on any of the players' electronic bingo cards match a game-winning pattern, process flow proceeds to step 528 where any player with a game-winning pattern is awarded a prize. That is, the award or prize corresponding to a specific game-winning pattern is deposited into the respective player's running balance if the player has an electronic bingo card, the dobs of which match the game-winning pattern. As noted above, the prize is directly proportional to the odds of matching the game-winning pattern. The player's balance as shown on the touch screen of the player's game terminal reflects the addition of the prize. In the presently-described embodiment, the player is awarded the prize associated with the best game-winning pattern exhibited by the player's card even if it exhibits multiple game-winning patterns. The order of game-winning patterns is established at step 500, but the “best” game-winning pattern is typically defined as the pattern associated with the lowest probability of occurrence. It should be understood, however, that a system administrator may define game-winning patterns and the prizes and order associated therewith as desired.

In another embodiment, system 200 displays all 30 numbers at once on each terminal's display at step 524, rather than displaying each individual number sequentially as described above. At step 526, processor 220 automatically dobs each player's electronic bingo card for each number on the card that matches any of the 30 numbers. Process flow proceeds directly to step 528, where any player with a game-winning pattern is awarded the prize corresponding to the game-winning pattern. It should be understood that at least one game-winning pattern will occur due to the confirmation of such performed by system 200 at step 520 when the ball drop was selected.

At step 530, processor 220 presents an inquiry to each player via the touch screen of the player's respective game terminal whether the player would like to participate in another game, to which the player responds by selecting predetermined indicia using the touch screen. It should be understood that once a game-winning pattern is exposed at step 526, process flow directs all players involved in the game to step 528 including those whose cards do not exhibit a game-winning pattern. At step 528, prizes are awarded to those players who have a card exhibiting a game-winning pattern, and process flow directs all players involved in the game to step 530 where the inquiry described above is presented to each player. If the player responds in the affirmative to the inquiry, process flow proceeds to step 532 where system 200 asks the player if the player would like to retain the current electronic bingo card. If the player responds in the affirmative, process flow returns to step 508 and proceeds in the manner described above.

If the player desires a new card, process flow returns to step 502 where the player must pay another entry fee to receive another randomly generated bingo card. Process flow then proceeds in the manner described above. Thus, it should be understood that a player must pay for each newly generated card that the player will use, but does not repay the entry fee as long as the player continues to use the same card. If the player chooses at step 530 not to play again, system 200 cashes out the player at step 534. If the player has a positive balance, money corresponding to the balance is returned to the player via payment terminal 228.

FIG. 7 illustrates the processes for conducting a game of bingo in accordance with another embodiment of the present invention. Referring to FIGS. 2, 3, and 7, process flow proceeds to step 508 in a manner identical to that described above with respect to FIG. 6. Process flow then proceeds to step 600 where Players 1 and 2 are asked to place their respective bets. In a preferred embodiment, each player is required to bet a minimum amount, such as thirty cents ($0.30). Players may increase their respective bets using the terminal's touch screen. For instance, the touch screen presents selectable indicia on the screen with the text “Increase Bet” and “Max Bet.” Pressing the area corresponding to the “Increase Bet” increases the player's bet by a predetermined amount. In the presently-described embodiment, each selection of this area increases the player's bet by a multiplier that corresponds to the number of times the area was selected by the user. For instance, selecting the area three times will increase the player's bet by a multiplier of 3. In a preferred embodiment, the multiplier may be increased 10 times before resetting to a value of 1. Selecting the area of the touch screen corresponding to the “Max Bet” immediately sets the multiplier to the maximum value, which, in this embodiment, is 10.

By way of example, Player 1 provides the entry free of ten cents ($0.10) at step 502. At step 600, the touch screen of game terminal 202 presents a request to Player 1 to provide the minimum bet fee of thirty cents ($0.30). Player 1 may decide to increase the bet by a multiplier of 4 and selects the appropriate area of the touch screen of terminal 202 four times. As a result, the bet is increased from thirty cents ($0.30) to one dollar and twenty cents ($1.20). Player 1 may decide to increase the bet to the maximum amount by selecting the appropriate area of the touch screen. As a result, the bet is increased to three dollars ($3.00). It should be understood by those of ordinary skill in the art that increasing the bet increases the prizes awarded for each game-winning pattern by the increase in the multiplier. Thus, increasing the multiplier 4 times also increases any prizes fourfold.

System 200 is configured to provide Player 1 with the ability to increase the minimum bet 4 times and then to select the maximum bet instead. Likewise, system 200 allows Player 1 to reset the desired bet to the minimum amount by selecting the area of the touch screen labeled “Increase Bet” a sufficient number of times. It should be understood by those of ordinary skill in the art that the entry fee, minimum bet, maximum bet, and multipliers may be defined as desired and are initialized at step 500.

Once Players 1 and 2 have selected their respective desired bet amounts, each player selects an area of the touch screen of the player's game terminal labeled “Place Bet” at step 602. Those of ordinary skill in the art will appreciate that the labels described above may be modified to suit the game's design. For instance, each player may select a portion of the respective touch screen labeled “Play Game,” “Spin,” etc. to indicate the player is ready to proceed. Should a player's balance fall below the minimum bet amount or below an amount needed to continue, system 200 invites the player to insert additional money using payment terminal 228. Similarly, each player may provide additional money via payment terminal 228 at any time the player is using a game terminal. Upon receipt of the money, the terminal's touch screen reflects the increase to the player's balance. Game play proceeds to step 518 and continues in the manner described above with respect to FIG. 6. Additionally, a player may finish playing at any time by pressing an area of the touch screen of the player's terminal labeled “Cash Out.” If the player's running balance reflects a positive amount, the balance is returned to the player via the respective terminal's cash and/or change dispenser.

In another embodiment, steps 600 and 602 precede step 508. In this embodiment, after selecting a card, process flow proceeds from steps 506 and 516 to step 600 and then to step 602 in a manner similar to that described above. After each player selects at step 602 the portion of the respective touch screen labeled “Place Bet” or “Begin,” process flow proceeds to step 508 where system 200 pauses until the system confirms that at least two players are involved in the game. Process flow then proceeds in a manner identical to that described above with respect to FIG. 6.

In another embodiment with reference to FIG. 7, process flow proceeds directly to step 508 from step 528 after prizes are awarded to all players whose boards exhibit a game-winning pattern. At this point, system 200 pauses for each player to make a selection using the player's respective touch screen. For example, with reference additionally to FIG. 3, each player may select portions of the player's touch screen corresponding to areas labeled “Cash Out,” “Place Bet” (or “Play Game”), “New Card,” “Increase Bet,” or “Max Bet.” Selecting “Cash Out” performs the functions described above with reference to step 534. Selecting “Place Bet” places the desired bet and informs system 200 that the player is ready to proceed with the game. Alternatively, selecting “Play Game” places the current bet and indicates the player is ready to proceed. System 200 pauses at step 508 until the system confirms that at least two players are ready to proceed as described above and then continues accordingly. Selecting “New Card” returns the player to step 502 where the player must pay the fee required to select a new bingo card. Process flow then proceeds in the manner described above. Selecting “Increase Bet” or “Max Bet” performs the functions described above with respect to steps 600 and 602. It should be understood that each player may make any of these selections at any time system 200 is idle or is awaiting a response or input from the player but not while engaging in the actual game. For instance, each player is unable to select the “Cash Out” or “New Card” areas of the player's respective touch screen during steps 524, 526, and 528. It should be further understood that, in an embodiment where steps 600 and 602 precede step 508 as described above, process flow proceeds directly to step 600 from step 528 in a manner similar to that set forth above and awaits each player's selection.

In another embodiment, each touch screen displays an area labeled “Help.” Upon selection by a player of this area, the touch screen displays a “help screen” which provides instructions to the player regarding all the options currently available to the player as described above. For instance, the help screen explains to the player what selection of certain areas of the touch screen will accomplish, such as selection of the “Max Bet” label. When viewing the help screen, the player always has the option to exit the help screen and continue as described above.

In the embodiments described above, data representative of each action of any player or of system 200 is written to memory 222 by processor 220. That is, system 200 maintains a log of all actions that take place before, during, and after a game of bingo. For instance, system 200 saves data to memory 222 representative of each player's bet for each bingo game played. This data may be stored within a data structure in memory 222, but is preferably stored within a database in memory maintained by server 210. Server 210 may periodically provide this data to a host system that manages multiple systems similar to system 200. This may be accomplished by email, file transfer protocol (“ftp”), really simple syndication (“RSS”) feed(s), or any other mechanism capable of transmitting information as necessary. It should be understood that the terminal that manages the bingo game in the embodiment described above with respect to FIG. 5 stores the data in memory 414. Similarly, the terminal provides this data to the host system. Alternatively, the host system may access server 210 or the terminals to retrieve the desired data.

In another embodiment that does not include the use of server 210, such as system 400 described above with respect to FIG. 5, processors 412 of the game terminals perform all or a portion of the methods described above. For instance, processor 412 of game terminal 402 performs the functions described above with respect to steps 502, 504, and 506 of FIG. 6, while processor 412 of game terminal 404 performs the functions described above with respect to steps 510, 512, and 516 of FIG. 6. If game terminal 404 was accessed by a user prior to a user accessing game terminal 402, then processor 412 of terminal 404 performs the functions described above with respect to the game of bingo, such as randomly selecting the 30 numbers from the number pool, as well as logging all player and system actions, as described above. Processor 412 of game terminal 402, however, continues to perform functions specific to the respective game terminal, such as displaying information to the user and receiving input from the user, and communicates data representative of such actions to processor 412 of game terminal 404 via connection 406. The implementation of such a shared processing system should be understood to those of ordinary skill in the art and is therefore not described in more detail.

It should be understood from the above description that system 200 requires the participation of at least two players before commencing play. One of ordinary skill in the art understands that a variable may be initialized at step 500 setting the minimum number of players required to reach step 508 before proceeding. For example, system 200 may be configured to require the access and use of four terminals prior to proceeding beyond step 508. Alternatively, system 200 may include all players that reach step 508 within a certain timeframe in a game as long as at least two players are present. For instance, system 200 may pause for a period of time, such as five seconds, each time a player reaches step 508 and is prepared to play. Thus, if other players reach step 508 during this time, they are added to the game in progress, and system 200 extends the waiting period another five seconds. One of ordinary skill in the art will also appreciate that a variable corresponding to the maximum number of players allowed per game, such as ten players, may be initialized at step 500. In the embodiment described above with respect to FIG. 6, when the number of players that reach step 508 is equal to this amount, process flow proceeds immediately to step 518 (or step 600 in the embodiment described above with respect to FIG. 7).

In a preferred embodiment, system 200 initiates a game each time two players reach step 508 and are prepared to play. For instance, Players 1 and 2 reach step 508 and engage in a game of bingo. Players 3 and 4 then reach step 508 and engage in another game of bingo. Upon completion of both games, Players 1 and 3 are prepared to play again, while Players 2 and 4 desire to change bingo cards. Players 1 and 3 subsequently reach step 508 and engage in a game of bingo. The next two players to reach step 508 and are prepared to play, engage in a game of bingo regardless of whether it is Player 1, 2, 3, or 4.

In the presently-described embodiment, each player's balance is represented as a cash value. That is, the player's balance as denoted on the touch screen of the player's terminal is an amount measured in dollars. It should be understood by those of ordinary skill in the art that each balance may be displayed as credits instead of cash. For instance, a balance of one dollar ($1.00) may be converted to credits, where one cent ($0.01) is equivalent to 1 credit. Thus, the player's balance would be presented as 100 credits. It should be further understood that system 200 may present the option of displaying the balance as cash or credits to each player. Specifically, each player may choose between having the player's balance presented as cash or as credits.

In an embodiment where the player's balance is displayed as credits (either automatically or by the player's choice), system 200 provides the player with an option to change the game's denom using the touch screen of the player's terminal. A denom is a quotient by which a player's credits are valued. In the presently-described embodiment, the default denom is 1 although it should be understood that the default may be altered as desired. That is, a player that has a balance of one dollar ($1.00) has 100 credits. The credits are divided by the denom, or 1, resulting in a balance of 100 credits. The player may alter the denom, thereby changing the quotient by which the credits are valued. If the player adjusts the denom to 2, the change is reflected in the player's balance, which is adjusted to 50 credits. If the player provides the terminal with another dollar ($1.00), 50 credits are added to the player's balance. The use and effect of denoms should be understood by those of ordinary skill in the art and are therefore not described in more detail.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

1.-24. (canceled)

25. A system for conducting a game of bingo comprising:
a server; and
at least two game terminals operatively connected to the server, wherein each terminal comprises a display and an input device and is associated with a payment terminal configured to receive payment from users, wherein the server is configured to:
establish at least one game winning pattern for the game of bingo;
determine that a fee for the game has been paid by at least two users;
generate at least one bingo game board for each user via a respective game terminal;
allow the user to purchase the generated bingo game board or request, an unlimited number of times, the generation of another bingo game board for purchase;
determine that a bingo game board has been purchased by at least two users;
generate a first ball drop for the game of bingo;
determine if at least one of the bingo game boards matches the at least one game winning pattern for the game based on the first ball drop for the game;
if the first ball drop does not cause at least one of the bingo game boards to match at least one game winning pattern for the game, generate consecutive ball drops until at least one of the bingo game boards matches the at least one game winning pattern for the game based on the ball drop;
allow the game to proceed only after the server has determined that each of the at least two users is playing the game, that each of the at least two users has accepted at least one bingo game board presented via the respective user's game terminal, and that at least one of the at least two users will obtain a game winning pattern; and
instruct at least one of the game terminals to award a prize to at least one user that obtains a game winning pattern.

26. The system of claim 25 wherein each game terminal is configured to accept a bet for the game.

27. The system of claim 25 wherein the prize is proportional to the at least one winning pattern exhibited by the bingo game board.

28. The system of claim 27 wherein the prize comprises points.

29. The system of claim 28 wherein the points may be utilized to spin an electronically-simulated reel, providing an entertaining display of the game prize.

30. The system of claim 25 wherein one of the game terminals comprises the server.

31. The system of claim 25 wherein the connection between at least one of the game terminals to the server is accomplished via a wide area network.

32. The system of claim 31 wherein the wide area network is the Internet.

33. The system of claim 25 wherein the payment terminal is configured to provide one of the users with a prize.

34. The system of claim 25 wherein the payment terminal comprises a card reader.

35. The system of claim 25 wherein the payment terminal comprises a cash acceptor.

36. The system of claim 25 wherein at least one of the game terminals includes a touch screen that comprises the display and the input device of the at least one game terminal.

37. The system of claim 25 wherein the input device is a touchpad.

38. The system of claim 25 wherein the system records the number of bingo game boards purchased.

39. The system of claim 25 wherein, upon instruction, the system generates a report of the number of bingo boards purchased.

40. A method for providing a game of bingo to a plurality of users comprising the steps of:
receiving a fee from each user at a respective game terminal;
presenting a bingo game board to each user via the respective game terminal;
allowing the user to purchase the generated bingo game board or request, an unlimited number of times, the generation of another bingo game board for purchase;
determining that at least two human users have purchased bingo game boards before allowing the game to proceed;
determining that the bingo game board of one of the at least two human users presents a winning pattern before allowing the game to proceed; and
allowing the game to proceed and awarding a prize to a winner of the game.

41. The method of claim 40 wherein the step of awarding a prize to a winner of the game comprises awarding a prize to each winner of the game.

42. The method of claim 40 wherein the prize is proportional to the at least one game winning pattern of the bingo game board.

43. The method of claim 40 wherein the prize comprises points.

44. The method of claim 43 wherein the points may be utilized to spin an electronically-simulated reel, providing an entertaining display of the game prize.
